(19) United States
(12) Patent Application Publication
(10) Pub. No.: US 2018/0192806 A1
(43) Pub. Date: Jul. 12, 2018

(54) COLLAPSIBLE DECORATIVE HANGING DEVICE

(71) Applicant: ENESCO, LLC, ITASCA, IL (US)

(72) Inventors: Kristi Pierro, Independence, MN (US); ASHLEY SCHNEIDER, BLOOMINGTON, MN (US)

(21) Appl. No.: 15/402,450

(22) Filed: Jan. 10, 2017

(51) Int. Cl. A47G 33/00; F16M 13/00

(52) U.S. Cl. CPC A47G 33/00; F16M 13/00

(57) ABSTRACT

A collapsible hanging decoration capable of hanging on an object such as a bannister, railing, wreath, or on an article that contains a narrow, horizontally oriented surface.

### FIELD OF THE INVENTION

The present invention relates generally to the field of hanging decorations and more specifically to collapsible hanging ornaments.

### BACKGROUND OF THE INVENTION

During various times of the year, most notably during holiday periods, it is common to adorn homes with decorations that depict seasonal fictional characters associated with the corresponding holiday period. For example, during the Christmas season, it is common to adorn homes with ornaments, lights, inflatables, and statues. Bannisters and staircase railings are areas that are commonly decorated during holiday seasons. However, because of their dimensions, options for decorating these areas of one's home are commonly limited, for example, to garlands and related accessories.

There exists a need among for an alternative decoration that can be placed on bannisters, railings, and related areas which depicts seasonal fictional characters or other designs. There further exists a need that such a decoration be collapsible or otherwise compressible to facilitate storage when the decoration is not being displayed.

### SUMMARY OF THE INVENTION

The present invention is directed to a collapsible hanging decoration capable of hanging on an object such as a bannister, railing, wreath, or on any article that contains a narrow, horizontally oriented bar or other similar area.

The present invention is generally comprised of four elements: (1) a front piece, (2) a rear piece, (3) a spacer bar, and (4) hinge elements connecting the spacer bar to the front piece and the rear piece.

In an embodiment, the front piece can feature the upper portion of an object such as a seasonal fictional character, a holiday design (e.g., a snowflake or a pumpkin) or an animal and the rear piece can feature a corresponding lower portion of the object. The spacer bar can be attached to the rear side of the front piece and to the front side of the rear piece by the hinge elements, joining those two pieces together in an erectable or collapsible manner.

It is an object of the present invention to create the illusion of an object such as a seasonal fictional character, a holiday design or an animal hanging on a structure such as a bannister, railing, wreath, or other horizontally oriented bar by resting the bottom of a horizontal beam of the spacer on the top of said article.

It is still another object of the present invention that the decoration be collapsible to facilitate storage when the decoration is not being displayed.

Additional objects and advantages of the invention will become apparent as the following detailed description of the embodiments is read in conjunction with the accompanying drawings which illustrate such embodiments.

### BRIEF DESCRIPTION OF THE DRAWINGS

While the present invention is described with particularity in the claims annexed to and forming a part of this specification, a better understanding of the invention can be had by reference to the following description taken in conjunction with the accompanying drawings in which:

FIG. 1 depicts a front left perspective view of a collapsible hanging decoration of the present invention resting on a railing;

FIG. 2 depicts a front elevational view thereof;

FIG. 3 depicts a rear elevational view thereof;

FIG. 4 depicts a left side elevational view thereof;

FIG. 5 depicts a right side elevational view thereof;

FIG. 6 depicts a top plan view thereof;

FIG. 7 depicts a bottom plan view thereof;

FIG. 8A depicts an exploded right side elevational view thereof; and

FIG. 8B depicts a right side elevational view thereof with the front character piece rotating at the front hinged joint and the rear character piece rotating at the rear hinged joint.

### DETAILED DESCRIPTION OF EMBODIMENTS OF THE INVENTION

The present invention is directed to a collapsible hanging decoration 8 that is capable of being hung on or over a structure such as a bannister, railing, wreath, or on any object. The decoration 8 can include a narrow, horizontally oriented surface that imitates a seasonal fictional character, a holiday design or animal that can be hung on or over the surface the structure by the upper portion of the decoration 8.

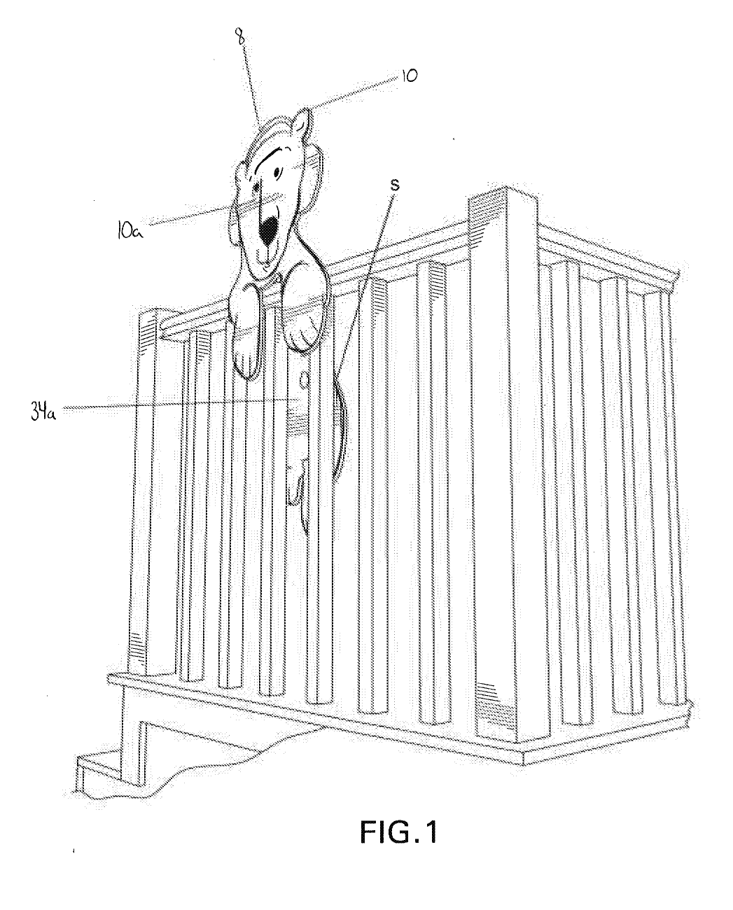

In an embodiment, the collapsible hanging decoration 8 is generally comprised of a front piece 10, a rear piece 34, and a spacer 36. As depicted in FIG. 1, when the decoration 8 is placed on a horizontally oriented surface S, the upper portion 10 of the decoration 8 is arranged near a first side of the surface S and the rear piece 34 arranged near a second side of the surface S such that the upper portion 10 of the decoration is arranged substantially adjacent opposite sides of the surface S.

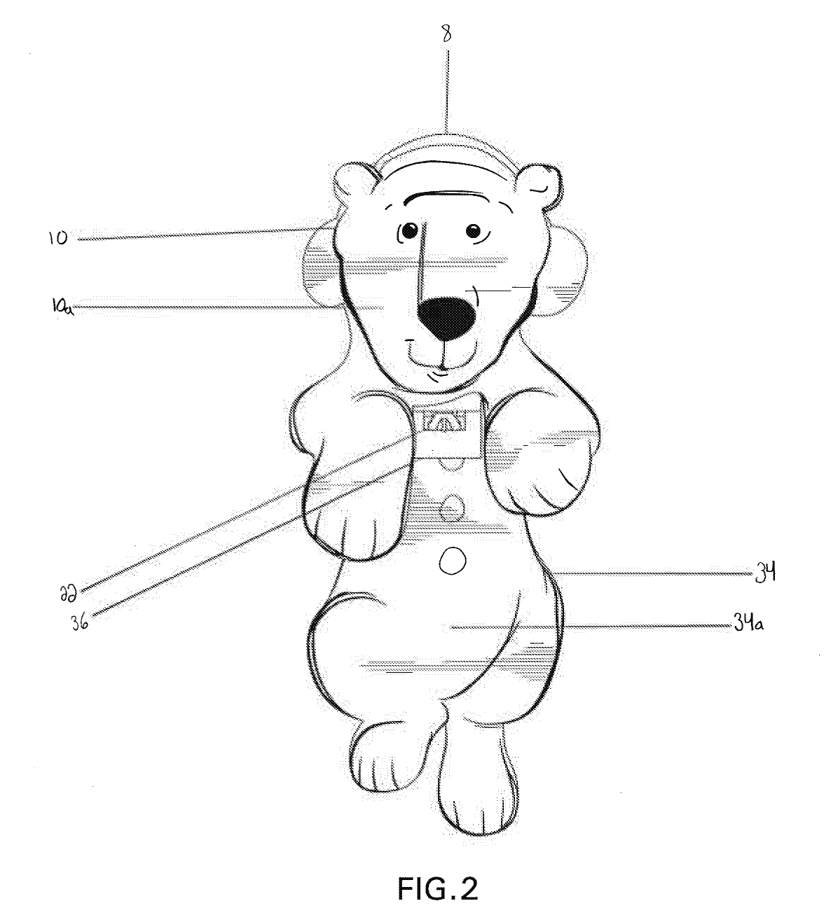

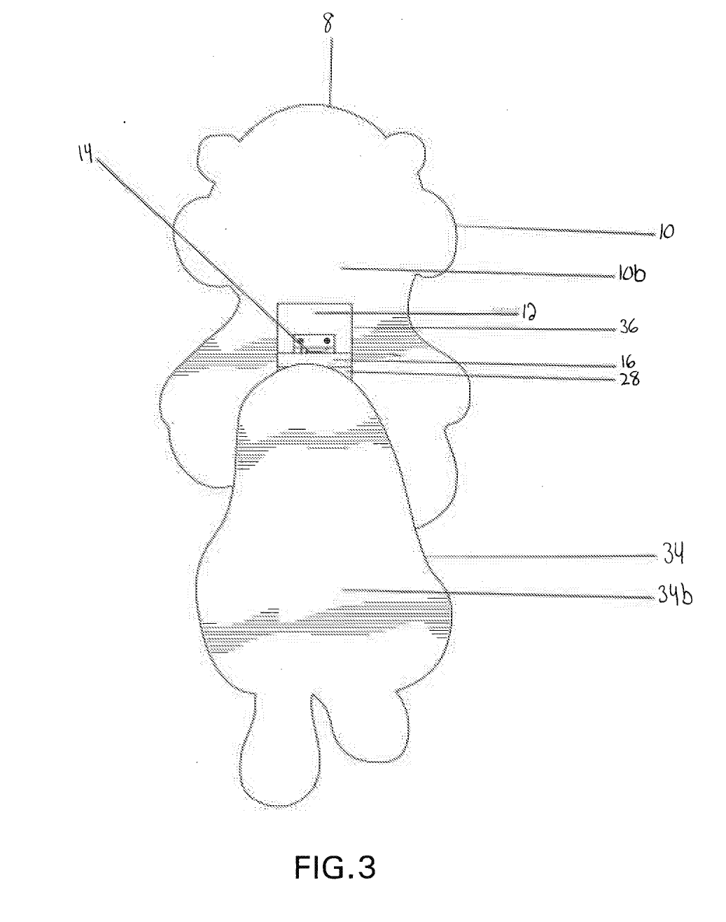

The front piece 10 can be a placard that has a front face 10a that features the upper portion of a seasonal fictional character, seasonal design, animal or the like while the rear piece 34 can be a placard that has a front face 34a which features the corresponding lower portion of the seasonal fictional character, seasonal design, animal or the like (e.g., bottom half of a character, snowflake, pumpkin, etc.). The front piece 10 and the rear piece 34 can be combined to form the entire character or design. The front piece 10 and the rear piece 34 are preferably predominantly rigid and made of wood, plastic, metal and/or another predominantly rigid but lightweight material (See FIG. 1 through FIG. 3).

In some embodiments, the rear face 10b of the front piece 10 and the rear face 34b of the rear piece 34 are not decorated. In other words, these surfaces retain the same look and feel of the material from which the front 10 and rear 34 pieces, respectively, are comprised.

Still in other embodiments, the rear face 10b of the front piece 10 and the rear face 34b of the rear piece 34 can feature the rear side of, for example, a seasonal fictional character, a holiday design or animal. In other words, the rear face 10b of the front piece 10 can feature the back of the upper portion of the seasonal fictional character, holiday design or animal and the rear face 34b of the rear piece 34 will feature the back of the lower portion of the seasonal fictional character, holiday design or animal.

In an embodiment, the front piece 10 and the rear piece 34 can be both substantially two dimensional so as to adapt the decoration 8 to be entirely collapsible. In other embodiments, the front character piece 10 and/or the rear character piece 34 can be three-dimensional in order to create a more realistic representation of an object. For example, the facial features (i.e., nose, lips, or ears) or parts of the body (i.e., feet or arms) of a seasonal fictional character or an animal may extend past the planes of the respective placards to make the seasonal fictional character or animal appear more lifelike.

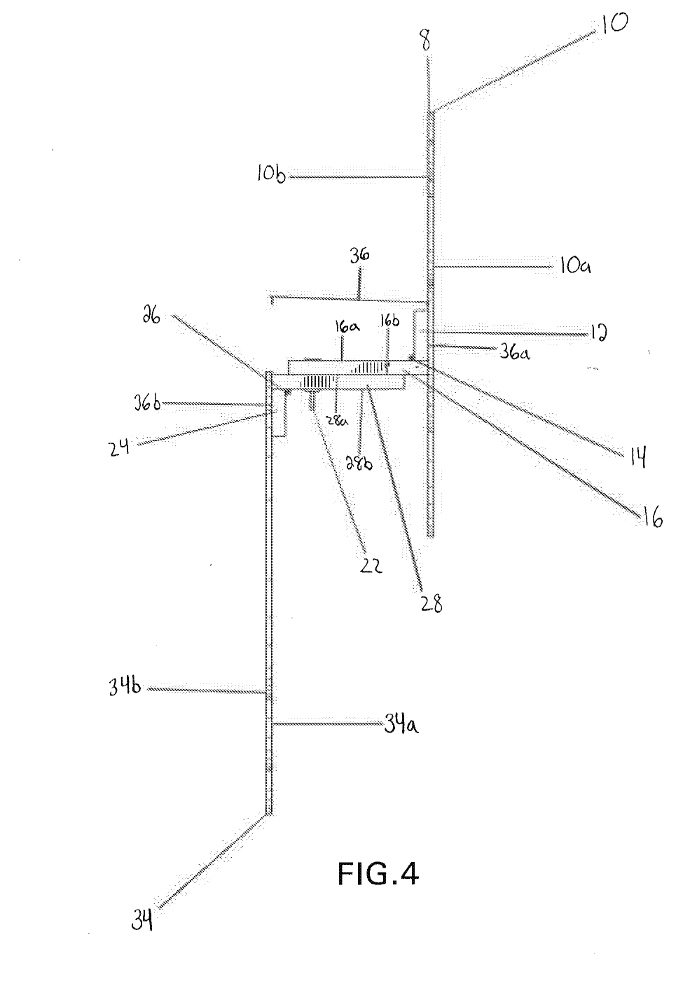

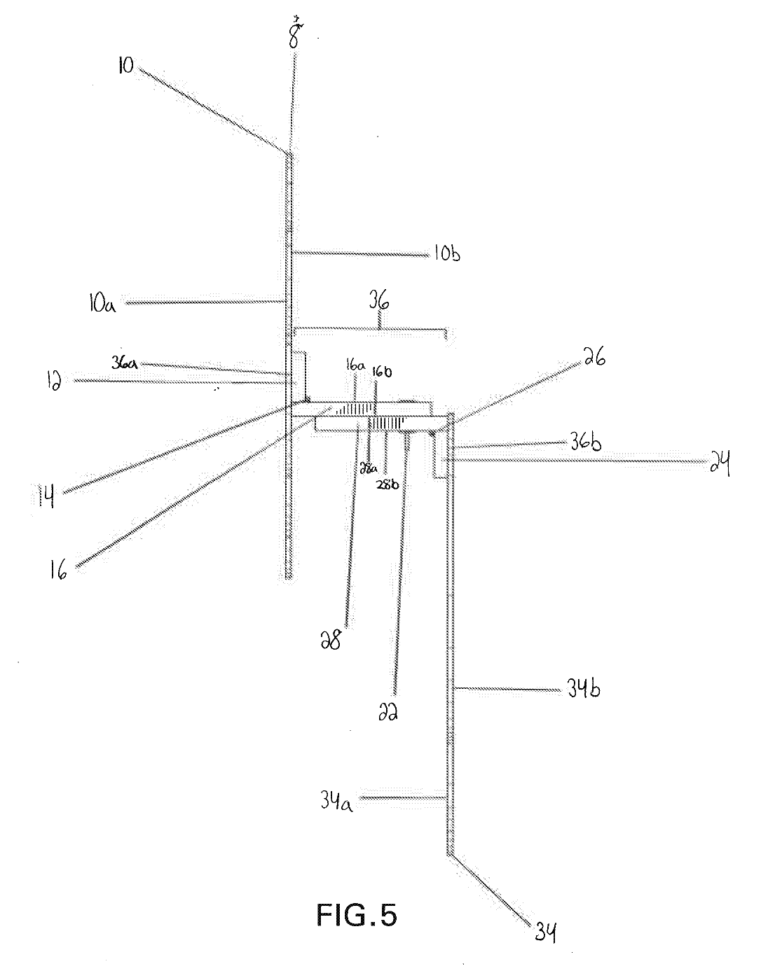

As can be seen, for example, in FIGS. 4 and 5, the spacer 36 connects the front piece 10 to the rear piece 34. The front 36a of the spacer 36 is attached to the back 10b of the front piece 10, and the back 36b of the spacer 36 is attached to the front 34a of the rear piece 34. The spacer 36 is preferably connected to the rear piece 34 at or near the top thereof. This positioning allows the spacer bar 36 and hinge elements 14, 26 to be hidden from view by the front piece 10 when viewed from the front 10a of the front piece 10. The spacer bar 36 is preferably connected to the front piece 10 at some point in the middle of the front piece 10. More specifically, the spacer bar 36 cannot be located at the very bottom of the front piece 10 because in such an embodiment, no part of the front piece 10 would be located below the spacer bar 36 to rest on the horizontal surface S and to help stabilize the decoration 8 on the horizontal surface S. In addition, the spacer bar 36 cannot be located at the very top of front character piece 10 because no part of the front piece 10 would be present above the spacer bar 36 to rotate at the hinge element 14. In addition, in such an embodiment, the front piece 10 would obscure the view of the rear piece 34 when viewed from the front of the front 10a of the front piece 10.

The spacer 36 is preferably predominantly rigid and made of wood, plastic, metal and/or some other predominantly rigid material.

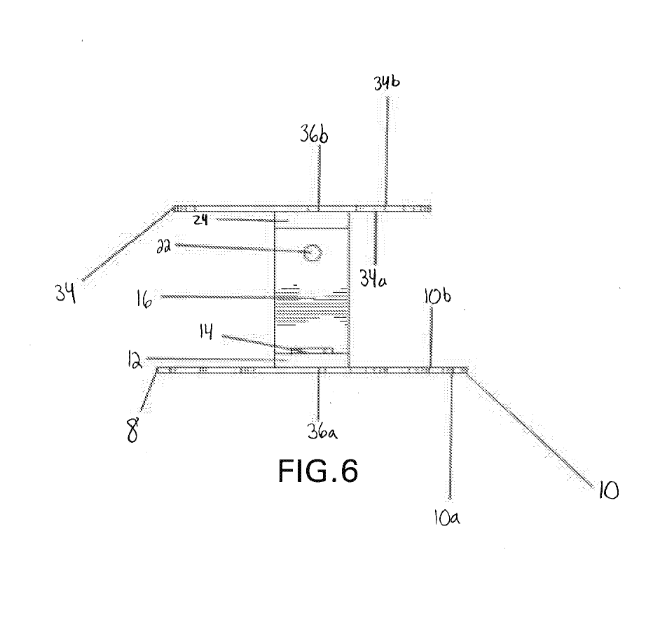

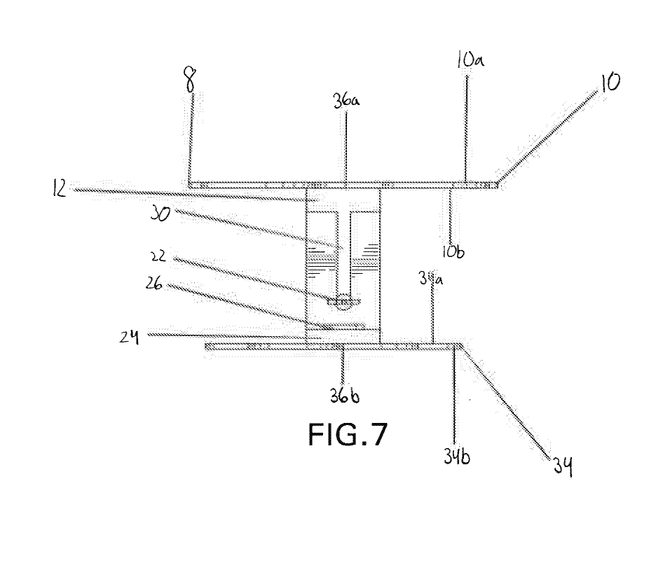

The spacer 36 contains hinge elements 14, 26 at oppose ends, which typically are in the form of a front foldable L-shaped bracket 20 and a rear foldable L-shaped bracket 32, respectively (See FIG. 4 to FIG. 7). The front foldable L-shaped bracket 20 is oriented approximately 180 degrees from the rear foldable L-bracket 32.

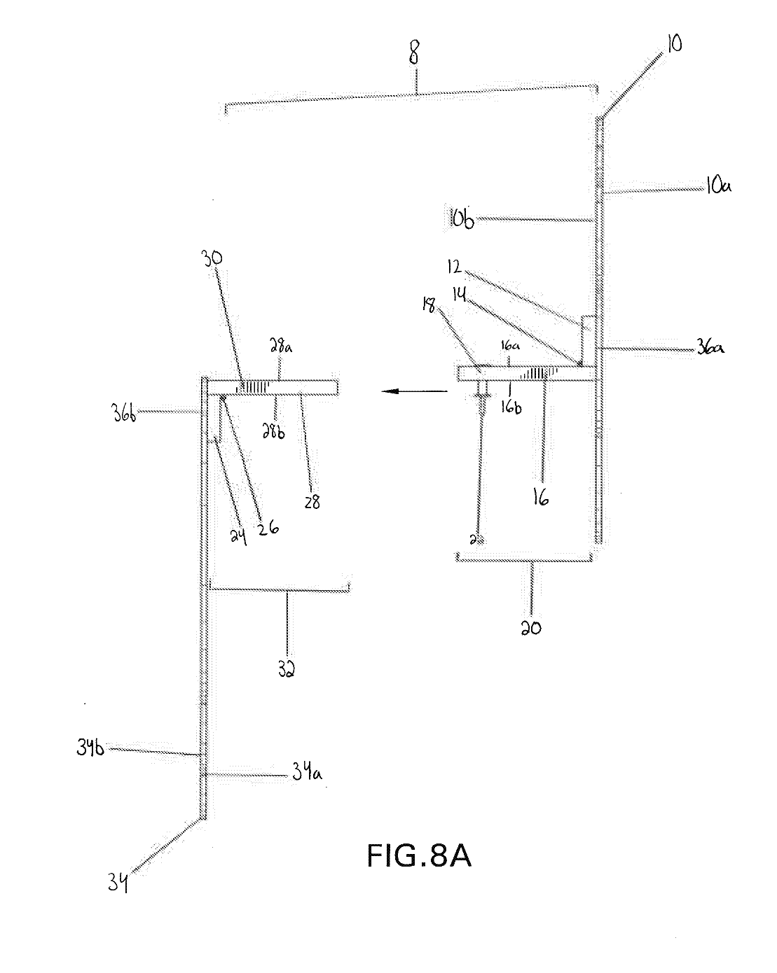

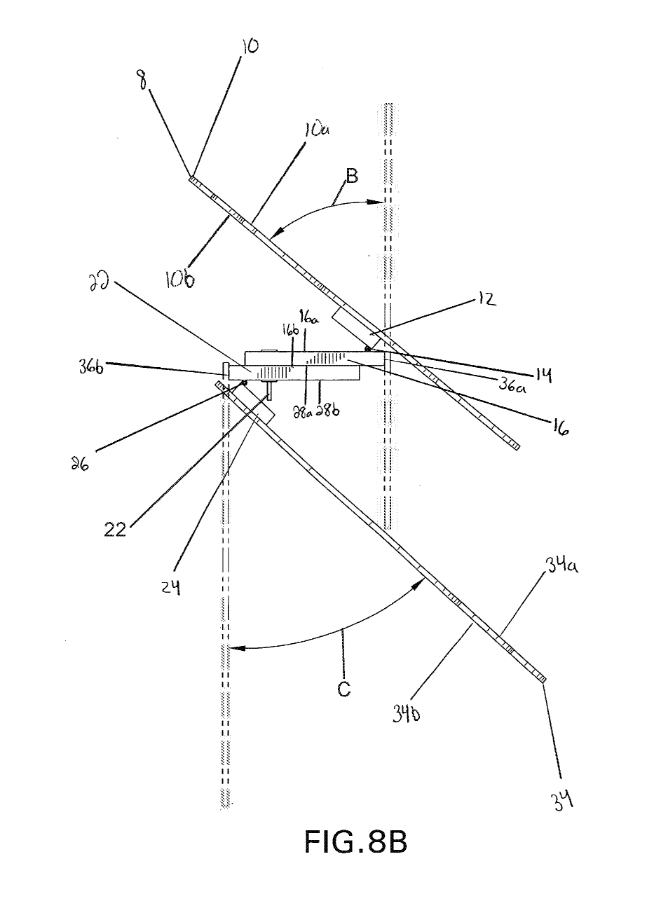

The front foldable L-shaped bracket 20 is connected to the back of the front piece 10b, and is comprised of a front vertical piece 12, a front hinged joint 14, and a front vertical horizontal piece 16. The front horizontal piece 16 may also contain a front opening 18 which extends from the top of the front horizontal piece 16a to the bottom of the front horizontal piece 16b (See FIG. 4, FIG. 5, and FIG. 8A).

The rear foldable L-shaped bracket 32 is connected to the front of the rear piece 34, and is comprised of a rear vertical piece 24, a rear hinged joint 26, and a rear horizontal piece 28. The rear horizontal piece 28 may also contain a rear elongated opening 30 which extends from the top of the rear horizontal piece 28a to the bottom of the rear horizontal piece 28b.

The front piece 10 and/or the rear piece 34 may be permanently attached to the spacer 36 such as through the use of a fastener (e.g., nails, glue, or some other binding agent).

In other embodiments of the hanging decoration 8, the front piece 10 and/or the rear piece 34 may be detachable from the spacer 36 such as through the use of VELCRO® (hook and loop fasteners), screws, or some other easily detachable binding agent. The use of a detachable front piece 10 and/or the rear piece 34 allows the hanging decoration 8 to be used with various designs.

As shown by the arrow A in an embodiment in FIG. 8A, the front foldable L-shaped bracket 20 can be brought together and connected to the rear foldable L-shaped bracket 32 through a connector rod 22, which may be a bolt, screw, pin, bar, or fastener placed through the front opening 18 and the rear opening 30 to secure the front horizontal piece 16 to the rear horizontal piece 28, and thusly the front piece 10 to the rear piece 34.

By using a front horizontal piece 16 and a rear horizontal piece 28, connected by a connector rod 22 or by some other means (as opposed to using a single horizontal bar as a spacer bar 36), the length of the hanging device 8 (that is, the distance between the front piece 10 and the rear piece 34) can be modified by movement along the axis of the spacer 36, by selecting where the connector rod 22 or other fastening means connects the front horizontal piece 16 to the rear horizontal piece 28. This would allow the length of the hanging device 8 to be modified to accommodate different sized objects on which the device 8 can be hung (e.g., bannister 5).

Preferably, the front horizontal piece 16 would be placed on top of the rear horizontal piece 28 when the respective pieces are being fastened in order to facilitate collapsing of the decoration when not in use. However, in alternative embodiments of the hanging device 8, the rear horizontal piece 28 may be placed on top of the front horizontal piece 16 when the respective pieces are being fastened to one another.

The hinge elements, such as the ones in the front foldable L-shaped bracket 20 and the rear foldable L-shaped bracket 32 may be fastened through other means, such as through the use of glue, staples, VELCRO®, clasps, or some other fastening means. In such an embodiment, the front opening 18 and the rear opening 30 may not be necessary and thus may not be included in the decoration.

Still in other embodiments of the hanging device 8, the front horizontal piece 16 and the rear horizontal piece 28 may be a single horizontal piece, and thus no fastening means would be necessary. In such an embodiment, the front piece 10 and the rear piece 34 would be permanently attached to one another through the spacer 36.

As shown in FIG. 8b, the front piece 10 is capable of rotating at the front hinged joint 14 and the rear piece 34 is capable of rotating at the rear hinged joint 26. As viewed from the right side of the decoration (as in FIG. 8b) the front character piece 10 is capable of rotating counter-clockwise in the direction of arrow B from zero degrees to ninety degrees (at which point it would be substantially parallel to the front horizontal piece 16). The rear character piece 34 is also capable of rotating counter-clockwise in the direction of arrow C from zero degrees to ninety degrees (at which point it would be substantially parallel to the rear horizontal piece 28).

When the front piece 10 and the rear piece 34 are each rotated in this manner to approximately ninety degrees, both the front piece 10 and rear piece 34 will be substantially parallel (that is, at an angle less than thirty degrees) to the spacer bar 36. At this position, the hanging decoration 8 would be in its collapsed state, allowing the user to more conveniently store the decoration 8 when not in use.

A user may create the illusion that a seasonal fictional character or other design is hanging onto an object, such as a bannister, railing, wreath, or other horizontally oriented bar S by resting the bottom of the rear horizontal piece 28b or the bottom of the front horizontal piece 16b on the top of object. In some embodiments (e.g., FIG. 1) the decoration 8 will appear to be hanging onto the banister by only its hands, or in this case, paws.

The decoration 8 will remain secured on an object due to the bottom of the rear horizontal piece 28b or the bottom of the front horizontal piece 16b resting on the top of the object. In addition, the front piece 10 and the rear piece 34 may help secure the decoration to object by also resting on said object.

While the invention has been described with reference to one or more embodiments, it is to be understood that these embodiments are merely illustrative of the principles of the invention. Accordingly, the embodiments described herein should be considered as exemplary, and not limiting.

What is claimed is:

1. A collapsible, hanging, decorative ornament placeable on an object, comprising:
a front piece comprising the upper portion of a design on the front of said front piece;
a rear piece comprising the lower portion of said design on the front of said rear piece;
a spacer bar; and
a pair of hinge elements attached to the spacer bar, one element connected to the front piece and the other element connected to the rear piece,
wherein the hinge elements are placed on opposite ends of the spacer bar such that the front piece is rotatable at the hinge element towards the direction of the rear piece to the point that the front piece and spacer bar are substantially parallel and the rear piece is rotatable at the hinge element towards the direction of the front piece to the point that the rear piece and the spacer bar are substantially parallel, and
wherein the ornament is stably placeable on a bannister or the like by resting the spacer bar on said object.

2. The ornament of claim 1, wherein:
a front spacer bar is connected to the front piece;
a rear spacer bar is connected to the rear piece;
the front and rear spacer bar each contain an opening; and
the front spacer bar and the rear spacer bar are connected by a fastener inserted into the opening of the respective spacer bars.

3. The ornament of claim 1, wherein the distance between the front piece and the rear piece is adjustable along the axis of the spacer bar.

4. The ornament of claim 1, wherein the distance between the front piece and the rear piece is fixed.

5. The ornament of claim 1, wherein the spacer bar is connected at or near the top of the rear placard.

6. The ornament of claim 1, wherein the spacer bar is connected at or near the middle of the front placard.

7. The ornament of claim 1, wherein the front piece and the rear piece are substantially two-dimensional.

8. The ornament of claim 1, wherein the front piece is attached to the front foldable L-shaped bracket and the rear piece is attached to the rear foldable L-shaped bracket.

9. The ornament of claim 1, wherein the front piece is detachable from the front foldable L-shaped bracket.

10. The ornament of claim 1, wherein the back of the front piece contains the back of the upper portion of a seasonal fictional character and the back of the rear piece contains the back of the lower portion of a seasonal fictional character.

11. A collapsible, hanging, decorative ornament placeable on an object, comprising:
a front piece comprising the upper portion of a holiday design on the front of said front piece;
a rear piece comprising the lower portion of an imaginary holiday design on the front of said rear piece;
a spacer bar;
a pair of hinge elements, one connected to the front piece and the other connected to the rear piece,
wherein the hinge elements are placed on opposite ends of the spacer bar such that the front piece is rotatable at the hinge element towards the direction of the rear piece to the point that the front piece and spacer bar are substantially parallel and the rear piece is rotatable at the hinge element towards the direction of the front piece to the point that the rear piece and the spacer bar are substantially parallel, and
wherein the ornament is stably placeable on the object by resting the spacer bar on said object.

12. The ornament of claim 11, wherein a front spacer bar is connected to the front piece and a rear spacer bar is connected to the rear piece, the front and rear spacer bar each contain an opening and the front spacer bar and the rear spacer bar are connected by a fastener inserted into the opening of the respective spacer bars.

13. The ornament of claim 11, wherein the distance between the front piece and the rear piece is adjustable.

14. The ornament of claim 11, wherein the distance between the front character piece and the rear character piece is fixed.

15. The ornament of claim 11, wherein the spacer bar is connected at or near the top of the rear piece.

16. The ornament of claim 1, wherein the spacer bar is connected at or near the middle of the front piece.

17. The ornament of claim 11, wherein the front piece and the rear piece are substantially two-dimensional.

18. The ornament of claim 11, wherein the front piece is irreversibly attached to the front foldable L-shaped bracket and the rear piece is irreversibly attached to the rear foldable L-shaped bracket.

19. The ornament of claim 11, wherein the front piece is detachable from the front foldable L-shaped bracket.

20. The ornament of claim 11, wherein the back of the front piece contains the back of the upper portion of a holiday design and the back of the rear piece contains the back of the lower portion of a holiday design.
